(19) United States
(12) Patent Application Publication
(10) Pub. No.: US 2023/0397615 A1
(43) Pub. Date: Dec. 14, 2023

(54) Kit for Presenting a Precooked Waffle on a Stick

(71) Applicant: Ibrahim Nemati, Fargo, ND (US)

(72) Inventor: Ibrahim Nemati, Fargo, ND (US)

(21) Appl. No.: 17/837,238

(22) Filed: Jun. 10, 2022

(51) Int. Cl. A21D 15/00; A21D 13/80

(52) U.S. Cl. CPC A21D 15/00; A21D 13/80

(57) ABSTRACT

A kit for presenting a precooked waffle includes a precooked waffle on a stick within a container and a packet containing a topping for the precooked waffle, the packet within the container.

### BACKGROUND

The present disclosure relates to a packaged food item, and more particularly to a kit for presenting a precooked waffle on a stick with toppings.

Food products, such as a toaster waffles, have become widely consumed as part of a meal due to their convenience and short preparation time. Waffle pops are at the delicious intersection of breakfast and dessert. Waffle pops are currently commercially made delicacies that are prepared at a bakery and are thus not readily available.

### SUMMARY

A kit for presenting a precooked waffle according to one disclosed non-limiting embodiment of the present disclosure includes a precooked waffle on a stick within a container and a packet containing a topping for the precooked waffle, the packet within the container.

A kit for presenting a precooked waffle according to another disclosed non-limiting embodiment of the present disclosure includes a precooked waffle on a stick within a container; a topping packet containing a liquid topping for the precooked waffle, the topping packet within the container; and a topping packet containing a solid topping for the precooked waffle, the topping packet within the container.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a kit for presenting a precooked waffle according to one disclosed non-limiting embodiment.

FIG. 2 is a perspective view of a kit according to another disclosed non-limiting embodiment.

FIG. 3 is a perspective view of a kit according to another disclosed non-limiting embodiment.

### DETAILED DESCRIPTION

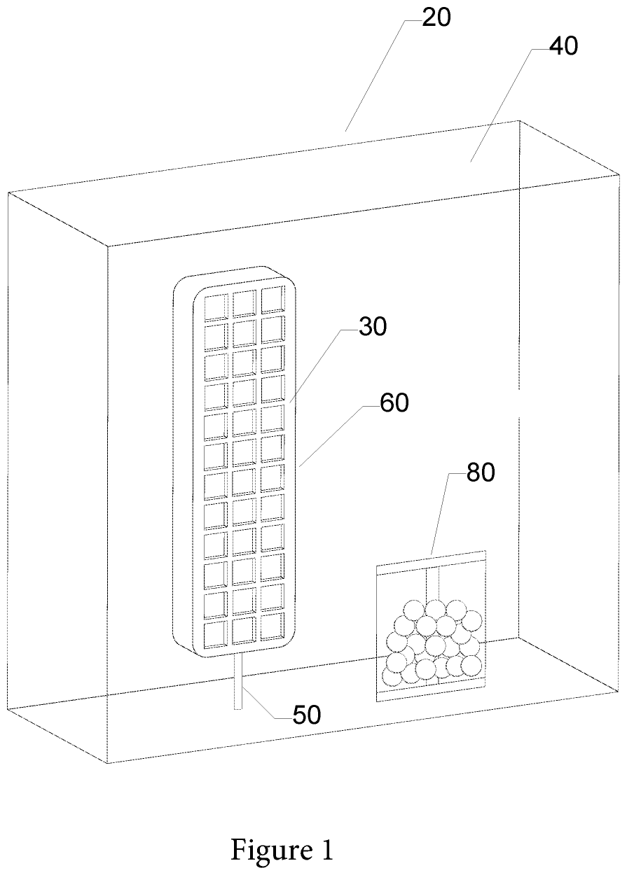

FIG. 1 schematically illustrates a kit 20 for presenting a precooked waffle 30. The kit 20 may be sold as a single package within a container 40 in which the precooked waffle 30 is precooked and ready to eat. That is, the precooked waffle 30 need not be frozen. The container 40 may be a bag, box, envelope, etc. In addition, the container 40 may be decorative for sale as a gift or may be relatively austere for incorporation into a meal ready to eat or other stored food.

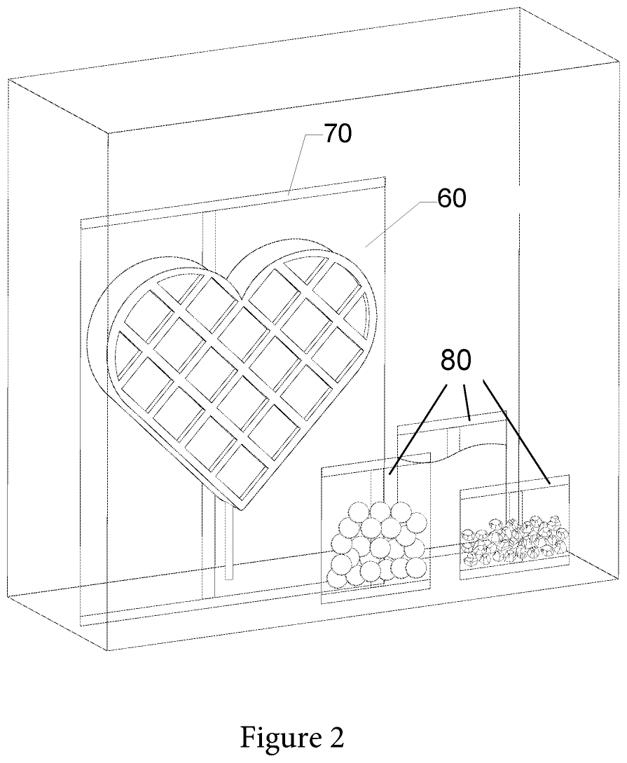

The precooked waffle 30 is affixed on a stick 50 or other handle type holder. The precooked waffle 30 may be of various shapes to provide an aesthetic “waffle pop” 60 that is ready to eat. For example, the precooked waffle 30 may be circular, trapezoidal, semi-circular, heart (shown in FIG. 2), rectangular, etc.

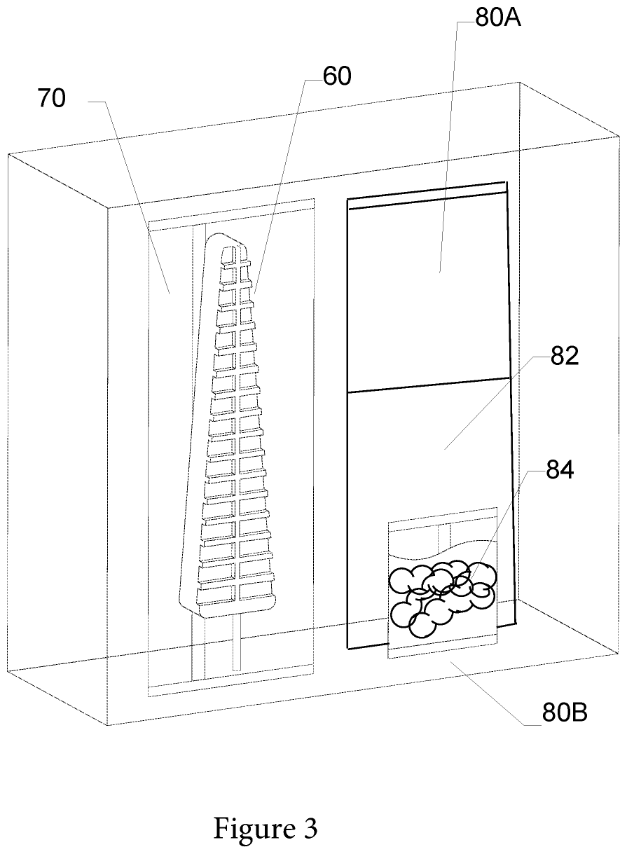

With Reference to FIG. 3, the precooked waffle pop 60 may also be stored in a sealed precooked waffle packet 70 that maintains the freshness of the precooked waffle 30. The sealed precooked waffle packet 70 may be an envelope of cellophane, Polyethylene or other material.

The kit 20 further includes one or more topping packets 80 that contain toppings for the precooked waffle 30. In one embodiment, the kit 20 includes a topping packet 80A containing a liquid topping 82 for the precooked waffle and a topping packet 80B containing a solid topping 84 for the precooked waffle, the topping packet within the container. In an embodiment, the topping packet 80A containing the liquid topping 82 may be sized to allow the precooked waffle pop 60 to be dipped therein. That is, the precooked waffle pop 60 may be first dipped into the topping packet 80A containing the liquid topping 82 then the solid topping 84 can be sprinkled thereon. The solid topping 84 may be of various granulated powdered, or other such types of relatively small candies, dried fruits, etc.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A kit for presenting a precooked waffle, comprising:
a container;
a precooked waffle on a stick within the container; and
a topping packet containing a topping for the precooked waffle, the topping packet within the container.

2. The kit as recited in claim 1, wherein the precooked waffle is pre-cooked.

3. The kit as recited in claim 1, wherein the precooked waffle is of a non-circular shape.

4. The kit as recited in claim 1, wherein the precooked waffle is of a heart shape.

5. The kit as recited in claim 1, wherein the precooked waffle on the stick is within a precooked waffle packet, the precooked waffle packet within the container.

6. The kit as recited in claim 1, wherein the precooked waffle packet is a sealed bag.

7. The kit as recited in claim 6, wherein the sealed bag is manufactured of a cellophane.

8. The kit as recited in claim 1, wherein the topping is a liquid.

9. The kit as recited in claim 1, wherein the topping is a solid.

10. A kit for presenting a precooked waffle, comprising:
a container;
a precooked waffle packet containing a precooked waffle on a stick, the precooked waffle packet within the container;
a topping packet containing a liquid topping for the precooked waffle, the topping packet within the container; and
a topping packet containing a solid topping for the precooked waffle, the topping packet within the container.

11. The kit as recited in claim 10, wherein the precooked waffle is heart shaped.

12. The kit as recited in claim 10, wherein the precooked waffle is of a non-circular shape.

13. The kit as recited in claim 10, wherein the precooked waffle is of a trapezoidal shape.

14. The kit as recited in claim 10, wherein the solid topping is granulated.

15. The kit as recited in claim 10, wherein the topping packet containing the liquid topping is sized to allow the precooked waffle to be dipped therein.
